(19) United States
(12) Patent Application Publication
(10) Pub. No.: US 2017/0092232 A1
(43) Pub. Date: Mar. 30, 2017

(54) OPTICAL TRUE TIME DELAY CIRCUIT IN A HEAD-MOUNTED DISPLAY

(71) Applicants: Brian Mullins, Altadena, CA (US); Matthew Kammerait, Studio City, CA (US)

(72) Inventors: Brian Mullins, Altadena, CA (US); Matthew Kammerait, Studio City, CA (US)

(21) Appl. No.: 15/283,215

(22) Filed: Sep. 30, 2016

Related U.S. Application Data
(60) Provisional application No. 62/235,114, filed on Sep. 30, 2015.

(51) Int. Cl. G09G 5/18; G02B 27/01; G09G 5/00; G06T 7/00; G06T 19/00; H04N 19/136

(52) U.S. Cl. CPC G09G 5/18; G06T 19/006; H04N 19/136; G09G 5/006; G06T 7/0075; G02B 27/0172; G02B 2027/0127; G02B 2027/0138; G02B 2027/014

(57) ABSTRACT

An augmented reality device includes a transparent optical display for displaying one or more depth-encoded images. The transparent optical display leverages an optical true time delay circuit communicatively coupled to a multi-layered optical element for displaying the one or more depth-encoded images. A light source is modified or modulated, which is then directed by the optical true time delay circuit, to create the depth-encoded images. A dynamic depth encoder determines which layers of the multi-layered optical element are to be energized, and the optical true time delay circuit is directed accordingly. In this manner, the optical true time delay circuit uses the inherent delay of transmitting the light as a controlled proxy for complex processing.

### CROSS-REFERENCE TO RELATED APPLICATIONS

This application claims the benefit of priority to U.S. Pat. App. No. 62/235,114, filed Sep. 30, 2015, and titled “OPTICAL TRUE TIME DELAY CIRCUIT IN A HEAD-MOUNTED DISPLAY,” the disclosure of which is hereby incorporated by reference in its entirety.

### TECHNICAL FIELD

The subject matter disclosed herein generally relates to a head-mounted display and, in particular, to a head-mounted display having an optical true time delay circuit that delays a signal output by a display controller and conveys the time-delayed signal to one or more layers of an optical element.

### BACKGROUND

Being able to display virtual content at different depths is challenging because the different depths require that the light be depth-encoded. However, depth-encoded light requires that it be directed to a corresponding optical element, such as a specifically configured diffraction grating, through which it can be viewed (or received). Conventional solutions for incorporating multiple optical elements into a single display to receive light encoded at different depths typically have slow refresh rates and low resolutions. These conventional solutions are thus not viable solutions for displaying virtual content that changes frequently or that is preferably viewed at higher resolutions.

### BRIEF DESCRIPTION OF THE DRAWINGS

Some embodiments are illustrated by way of example and not limitation in the figures of the accompanying drawings.

FIG. 1 is a block diagram illustrating an augmented reality device, according to an example embodiment, coupled to a transparent optical display.

FIG. 2 is a block diagram illustrating different types of sensors used by the augmented reality device of FIG. 1, according to an example embodiment.

FIG. 3 is a block diagram illustrating a signal pathway, according to an example embodiment, from a display controller of FIG. 1 to an optical element of FIG. 1.

FIG. 4 is another block diagram illustrating the signal pathway, according to another example embodiment, from the display controller of FIG. 1 to the optical element of FIG. 1.

FIG. 5 illustrates a method, in accordance with an example embodiment, for communicating a video signal to an optical element of the augmented reality device via an optical true time delay circuit.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The systems and methods disclosed herein generally relate to a head-mounted display having an optical true time delay circuit integrated therein. The optical true time delay circuit includes one or more physical waveguides which delay a signal by a preconfigured time relative to the original signal. Each of the one or more physical waveguides are communicatively coupled (e.g., via an optical and/or electrical transmission medium) to an optical element that displays an image encoded by the delayed signals. The optical element may include layers of etched gratings at various depths, where each layer corresponds to a waveguide of the optical true time delay circuit. A micro-electro-mechanical systems (MEMS) signal router is configured to route each of the signals output by a physical waveguide of the optical true time delay circuit to a corresponding layer of the optical element.

Accordingly, in one embodiment, this disclosure provides for a device configured to display augmented reality images, the device comprising a display controller configured to communicate a depth encoded image, the depth encoded image including a plurality of image portions, where each image portion is associated with a determined depth, a time delay circuit in communication with the display controller and configured to receive the depth encoded image, the time delay circuit comprising a plurality of waveguides, each waveguide configured to delay a corresponding image portion of the depth encoded image selected from the plurality of image portions, and an optical element in communication with the time delay circuit, the optical element configured to display one or more image portions selected from the plurality of image portions.

In another embodiment of the device, the device includes a depth sensor configured to acquire a plurality of depth values, wherein the determined depth associated with each of the image portions selected from the plurality of image portions is assigned a depth value selected from the plurality of depth values.

In a further embodiment of the device, the device includes a micro-electro-mechanical systems (MEMS) signal router in communication with the time delay circuit and the optical element, the MEMS signal router configured to transmit at least one image portion delayed by at least one waveguide of the time delay circuit to the optical element.

In yet another embodiment of the device, each waveguide of the time delay circuit is configured to delay the corresponding image portion by different amounts of time.

In yet a further embodiment of the device, the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

In another embodiment of the device, each image portion of the depth encoded image is assigned a waveguide of the time delay circuit based on its corresponding determined depth.

In a further embodiment of the device, the optical element comprises a plurality of layers, each layer selected from the plurality of layers being associated with a corresponding waveguide of the time delay circuit.

In addition, this disclosure provides for a method that includes for displaying augmented reality images, the method comprising communicating, by a display controller, a depth encoded image, the depth encoded image including a plurality of image portions, where each image portion is associated with a determined depth, receiving, by a time delay circuit, the depth encoded image, the time delay circuit comprising a plurality of waveguides, each waveguide configured to delay a corresponding image portion of the depth encoded image selected from the plurality of image portions, and displaying, by an optical element, one or more image portions selected from the plurality of image portions.

In another embodiment of the method, the method includes acquiring, by a depth sensor, a plurality of depth values, wherein the determined depth associated with each of the image portions selected from the plurality of image portions is assigned a depth value selected from the plurality of depth values.

In a further embodiment of the method, the method includes transmitting, by a micro-electro-mechanical systems (MEMS) signal router in communication with the time delay circuit and the optical element, at least one image portion delayed by at least one waveguide of the time delay circuit to the optical element.

In yet another embodiment of the method, the method includes delaying, by each waveguide of the time delay circuit, the corresponding image portion by different amounts of time.

In yet a further embodiment of the method, the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

In another embodiment of the method, each image portion of the depth encoded image is assigned a waveguide of the time delay circuit based on its corresponding determined depth.

In a further embodiment of the method, the optical element comprises a plurality of layers, each layer selected from the plurality of layers being associated with a corresponding waveguide of the time delay circuit.

Moreover, this disclosure provides for a machine-readable medium that stores computer-executable instructions that, when executed by one or more hardware processors, cause an augmented reality device to perform a plurality of operations that includes communicating, by a display controller, a depth encoded image, the depth encoded image including a plurality of image portions, where each image portion is associated with a determined depth, receiving, by a time delay circuit, the depth encoded image, the time delay circuit comprising a plurality of waveguides, each waveguide configured to delay a corresponding image portion of the depth encoded image selected from the plurality of image portions, and displaying, by an optical element, one or more image portions selected from the plurality of image portions.

In another embodiment of the machine-readable medium, the plurality of operations further comprises acquiring, by a depth sensor, a plurality of depth values, wherein the determined depth associated with each of the image portions selected from the plurality of image portions is assigned a depth value selected from the plurality of depth values.

In a further embodiment of the machine-readable medium, the plurality of operations further comprises transmitting, by a micro-electro-mechanical systems (MEMS) signal router in communication with the time delay circuit and the optical element, at least one image portion delayed by at least one waveguide of the time delay circuit to the optical element.

In yet another embodiment of the machine-readable medium, the plurality of operations further comprises delaying, by each waveguide of the time delay circuit, the corresponding image portion by different amounts of time.

In yet a further embodiment of the machine-readable medium, the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

In another embodiment of the machine-readable medium, each image portion of the depth encoded image is assigned a waveguide of the time delay circuit based on its corresponding determined depth.

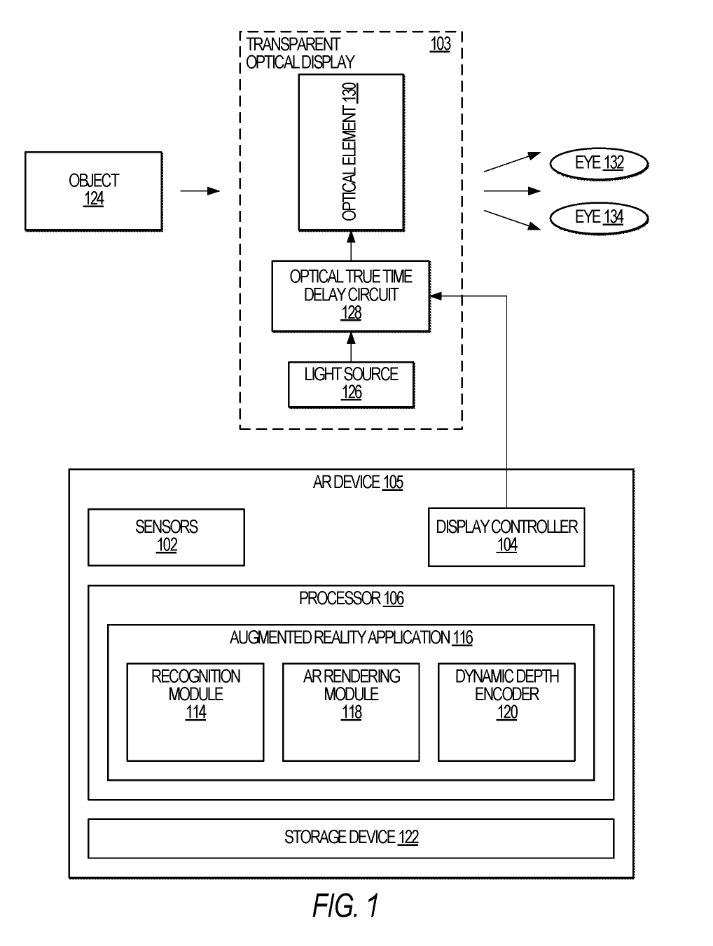

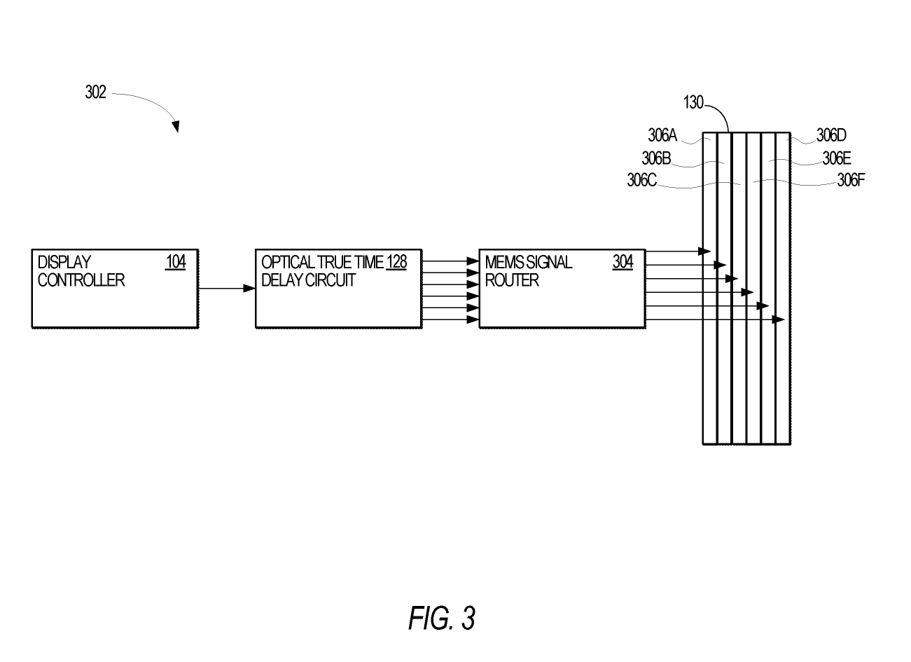

FIG. 1 is a block diagram illustrating an augmented reality device 105, according to an example embodiment, coupled to a transparent optical display 103. The transparent optical display 103 includes a light source 126 communicatively coupled to an optical true time delay circuit 128, which is further communicatively coupled to an optical element 130. Light reflected off an object 124 travels through the optical element 130 to the eyes 132, 134 of a user. In one embodiment, and as discussed with reference to FIG. 3, the optical true time delay circuit 128 includes one or more waveguides, which transport light from the dedicated light source 126 to the optical element 132. Examples of the light source 126 include laser light, light emitting diodes (“LEDS”), organic light emitting diodes (“OLEDS”), cold cathode fluorescent lamps (“CCFLS”), or combinations thereof. Where the light source 126 is laser light, the light source 126 may emit the laser light in the wavelengths of 620-750 nm (e.g., red light), 450-495 nm (e.g., blue light), and/or 495-570 nm (e.g., green light). In some embodiments, a combination of laser lights are used as the light source 126.

Additionally or alternatively, the transparent optical display 103 may also include, for example, a transparent OLED. In other embodiments, the transparent optical display 103 includes a reflective surface to reflect an image projected onto the surface of the transparent optical display 103 from an external source such as an external projector. In another example, the transparent optical display 103 includes a touchscreen display configured to receive a user input via a contact on the touchscreen display. The transparent optical display 103 may include a screen or monitor configured to display images generated by the processor 106.

In one embodiment, the one or more modifications are made to the projection from the light source 126. For example, the light source 126 may be modified at a rate high enough so that individual changes are not discernable to the naked eyes 132, 134 of the user. Modifications to the light source 130 include, but are not limited to, directional changes, angular changes, brightness and/or luminosity, changes in color, and other such changes or combination of changes. In one embodiment, changes to the light source 130 are controlled by the display controller 104. In addition, the display controller 104 may control the optical true time delay circuit to redirect the light based on the properties (or changed properties) of the light.

The optical element 130 may be constructed from one or more different types of optical elements. In one embodiment, the optical element 130 is constructed from layered and etched gratings, where each layer of the etched gratings is associated with a specified depth. In another embodiment, the optical element 130 is constructed from dynamic gratings. In yet a further embodiment, the optical element 130 is constructed from one or more individually focused microlenses. In this manner, the optical element 130 may include, or be constructed from, different types of optical elements or combinations of optical elements. Where the optical element is constructed from gratings, such as etched gratings and/or dynamic gratings, as discussed below with reference to FIG. 3, a micro-electro-mechanical system (MEMS) signal router (not shown in FIG. 1) directs light received from the object 124 and/or a display controller 104 to a specific layer of the etched gratings.

The AR device 105 includes sensors 102, a display controller 104, a processor 106, and a storage device 122. For example, the AR device 105 may be part of a wearable computing device (e.g., glasses or a helmet), a desktop computer, a vehicle computer, a tablet computer, a navigational device, a portable media device, or a smart phone of a user. The user may be a human user (e.g., a human being), a machine user (e.g., a computer configured by a software program to interact with the AR device 105), or any suitable combination thereof (e.g., a human assisted by a machine or a machine supervised by a human).

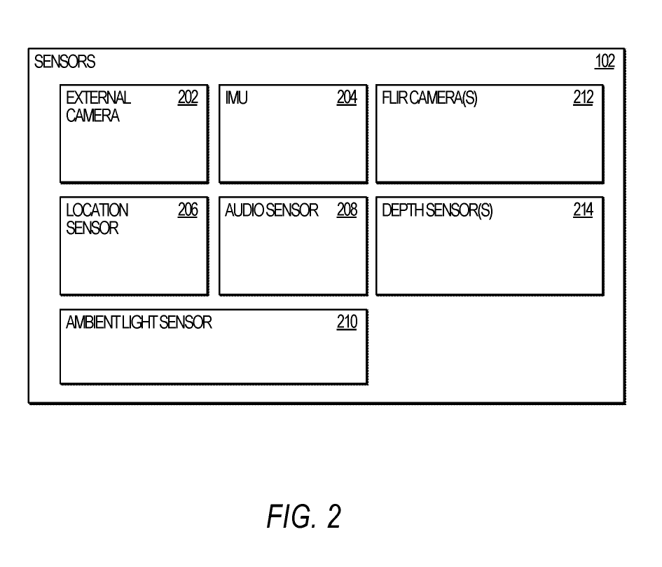

The AR device 105 includes various sensors 102 for obtaining images and depth information for encoding one or more signals corresponding to the obtained images. Referring to FIG. 2 is a block diagram illustrating different types of sensors 102 used by the AR device 105 of FIG. 1, according to an example embodiment. For example, the sensors 102 may include an external camera 202, an inertial measurement unit (IMU) 204, a location sensor 206, an audio sensor 208, an ambient light sensor 210, and one or more forward looking infrared (FLIR) camera(s) 212. One of ordinary skill in the art will appreciate that the sensors illustrated in FIG. 2 are examples, and that different types and/or combinations of sensors may be employed in the AR device 105.

The external camera 202 includes an optical sensor(s) (e.g., camera) configured to capture images across various spectrums. For example, the external camera 202 may include an infrared camera or a full-spectrum camera. The external camera 202 may include a rear-facing camera(s) and a front-facing camera(s) disposed in the AR device 105. The front-facing camera(s) may be used to capture a front field of view of the wearable AR device 105 while the rear-facing camera(s) may be used to capture a rear field of view of the AR device 105. The pictures captured with the front- and rear-facing cameras may be combined to recreate a 360-degree view of the physical environment around the AR device 105.

The IMU 204 may include a gyroscope and an inertial motion sensor to determine an orientation and/or movement of the AR device 105. For example, the IMU 204 may measure the velocity, orientation, and gravitational forces on the AR device 105. The IMU 204 may also measure acceleration using an accelerometer and changes in angular rotation using a gyroscope.

The location sensor 206 may determine a geolocation of the AR device 105 using a variety of techniques such as near field communication (NFC), the Global Positioning System (GPS), Bluetooth®, Wi-Fi®, and other such wireless technologies or combination of wireless technologies. For example, the location sensor 206 may generate geographic coordinates and/or an elevation of the AR device 105.

The audio sensor 208 may include one or more sensors configured to detect sound, such as a dynamic microphone, condenser microphone, ribbon microphone, carbon microphone, and other such sound sensors or combinations thereof. For example, the audio sensor 208 may be used to record a voice command from the user of the AR device 105. In other examples, the audio sensor 208 may be used to measure an ambient noise (e.g., measure intensity of the background noise, identify specific type of noises such as explosions or gunshot noises).

The ambient light sensor 210 is configured to determine an ambient light intensity around the AR device 105. For example, the ambient light sensor 210 measures the ambient light in a room in which the AR device 105 is located. Examples of the ambient light sensor 210 include, but are not limited to, the ambient light sensors available from ams AG, located in Premstaetten, Austria.

The one or more FLIR camera(s) 212 are configured to capture and/or obtain thermal imagery of objects being viewed by the Ar device 105 (e.g., by the external camera 202). The one or more FLIR camera(s) 212 are arranged or disposed within the AR device 105 such that the FLIR camera(s) 212 obtain thermal imagery within the environment of the AR device 105.

The sensors 102 may also include one or more depth sensors 214 to measure the distance of the object 124 from the transparent optical display 103. The sensors 102 may also include an additional depth sensor 214 to measure the distance between the optical element 130 and the eyes 132, 134. Examples of depth sensors 214 that may be affixed or mounted to the AR device 105 include, but are not limited to, a DUO MLX, a Stereolabs ZED Stereo Camera, an Intel RealSense F200, and other such depth sensors or combinations thereof.

In another example, the sensors 102 may include an eye tracking device (not shown) to track a relative position of the eye. The eye position data may be fed into the display controller 104 to generate a higher resolution of the virtual object and further adjust the depth of field of the virtual object at a location in the transparent display corresponding to a current position of the eye.

The display controller 104 communicates data signals to the transparent optical display 103 to display the virtual content. In one embodiment, the display controller 104 communicates data signals to an external projector to project images of the virtual content onto the transparent optical display 103. The display controller 104 includes a hardware that converts signals from the processor 106 to display signals for the transparent optical display 103.

In one embodiment, the display controller 104 is communicatively coupled to the optical true time delay circuit 128, which is also communicatively coupled to the optical element 130. As one of ordinary skill in the art will recognize, an optical true time delay circuit is a manufactured component that uses physical waveguides to introduce very precise delays into optical signal transmission. The optical true time delay circuit 128 allows for the signal from the display controller 104 to utilize the display to represent depth in an image. One technical benefit of sending the signals generated by the display controller 104 to the optical true time delay circuit 128 is that the optical true time delay circuit 128 provides a mechanism for light to be depth encoded by allowing for light to be routed to optical gratings or elements based on the precise delays in the light signal. The different gratings or elements diffract or reflect light with a known or controllable depth of field. This allows for the delay in light to be used as an efficient indicator of which depth the light should be displayed it. In summary, the optical true time delay circuit 128 allows for extremely fast, reliable and precise routing of this light using time delays instead of more costly methods (in terms of time/movement/processing). This light can then be routed to the appropriate gratings/elements at a high frequency and high density (i.e. high refresh rates, high resolutions).

The processor 106 may be any type of commercially available processor, such as processors available from the Intel Corporation, Advanced Micro Devices, Qualcomm, Texas Instruments, or other such processors. In addition, the processor 106 may include one or more processors operating cooperatively. Further still, the processor 106 may include one or more special-purpose processors, such as a Field-Programmable Gate Array (FPGA) or an Application Specific Integrated Circuit (ASIC). The processor 106 may also include programmable logic or circuitry that is temporarily configured by software to perform certain operations. Thus, once configured by such software, the processor 106 becomes one or more specific machines (or specific components of a machine) uniquely tailored to perform the configured functions and are no longer general-purpose processors.

The processor 106 may implement an AR application 116 for processing an image of a real world physical object (e.g., object 124) and for generating a virtual object in the transparent optical display 103 of the transparent optical display 103 corresponding to the image of the object 124. In one example embodiment, the AR application 116 may include a recognition module 114, an AR rendering module 118, and a dynamic depth encoder 120.

The recognition module 114 identifies the object pointed at the AR device 105. The recognition module 114 may detect, generate, and identify identifiers such as feature points of the physical object being viewed or pointed at by the AR device 105 using an optical device (e.g., sensors 102) of the AR device 105 to capture the image of the physical object. As such, the recognition module 114 may be configured to identify one or more physical objects. The identification of the object may be performed in many different ways. For example, the recognition module 114 may determine feature points of the object based on several image frames of the object. The recognition module 114 also determines the identity of the object using any visual recognition algorithm. In another example, a unique identifier may be associated with the object. The unique identifier may be a unique wireless signal or a unique visual pattern such that the recognition module 114 can look up the identity of the object based on the unique identifier from a local or remote content database. In another example embodiment, the recognition module 114 includes a facial recognition algorithm to determine an identity of a subject or an object.

Furthermore, the recognition module 114 may be configured to determine whether the captured image matches an image locally stored in a local database of images and corresponding additional information (e.g., three-dimensional model and interactive features) in the storage device 122 of the AR device 105. In one embodiment, the recognition module 114 retrieves a primary content dataset from a server (not shown), and generates and updates a contextual content dataset based on an image captured with the AR device 105.

The AR rendering module 118 generates the virtual content based on the recognized or identified object 116. For example, the virtual content may include a three-dimensional rendering of King Kong based on a recognized picture of the Empire State building.

The dynamic depth encoder 120 is configured to encode one or more depth levels for a given image to be displayed on the AR device 105. In one embodiment, the dynamic depth encoder 120 is a video coder optimized to capture two or more computer images or video sources and to consolidate the scene into separate picture and depth data. The depth data represents, at the pixel level, the plane where the composite stereoscopic image should be formed. In one embodiment, the dynamic depth encoder 120 is implemented using the Multiview Video Coding (MVC) extension of the H.264/AVC standard. One manner of depth encoding video using the MVC extension is described in the non-patent literature reference “Multiview-Video-Plus-Depth Coding Based on the Advanced Video Coding Standard,” by Hannuksela et al., IEEE Transactions on Image Processing, Vol. 22, No. 9 (September 2013). As known to one of ordinary skill in the art, the MVC extension ensures high-quality and resolution 3D video over a medium such as Blu-ray 3D. Additionally and/or alternatively, the dynamic depth encoder 120 is implemented using the Multiview Video plus Depth (MVD) extension of the H.265/HEVC standard.

The dynamic depth encoder 120 determines one or more discrete depth levels at which individual pixel elements of the optical element 132 are to be energized (e.g., activated and/or provided with light from the light source 126). The dynamic depth encoder 120 may then communicate the one or more discrete depth levels to the display controller 104, which, in turn, directs the optical true time delay circuit 128 accordingly. As the optical true time delay circuit 128 includes one or more MEMS signal routers, the individual activation of the one or more pixel elements of the optical element 132 are imperceptible to the eyes 132,134. The dynamic depth encoder 120 adjusts which depth levels of the optical element 132 are energized so as to manipulate depth of field of the virtual object. In one example, the dynamic depth encoder 120 adjusts the depth of field based on sensor data from the sensors 102. For example, the depth of field may be increased based on the distance between the transparent optical display 103 and the object 124. In another example, the depth of field may be adjusted based on a direction in which the eyes are looking.

The storage device 122 includes various modules and data for implementing the features of the AR device 105. The storage device 122 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable memory” should be taken to include a single medium or multiple media (e.g., a centralized or distributed database, or associated caches and servers) able to store the modules and the data. Accordingly, the storage device 122 may be implemented as a single storage apparatus or device, or, alternatively and/or additionally, as “cloud-based” storage systems or storage networks that include multiple storage apparatus or devices.

The optical element 130 may be constructed from one or more layers of a reflective material to effect the depth of field of the virtual object. As examples, the reflective materials may include polarization switchable materials, such as liquid crystal on silicon (LCoS). Additionally and/or alternatively, the optical element 130 may be constructed using one or more on electro-optic or acousto-optic substrates, such as lithium niobate. In particular, and in one embodiment, the optical element 130 is a multilayer lens. As discussed briefly above, and in one embodiment, the optical element 130 is constructed from multiple layers of etched or dynamic gratings or elements, where each grating or element is associated with a specified depth.

The optical true time delay circuit 128 introduces a time delay in the signal generated by the display controller 104. FIG. 3 is a block diagram illustrating a signal pathway 302, according to an example embodiment, from the display controller 104 to the optical element 130. As shown in FIG. 3, and in one embodiment, the signal pathway 302 includes a signal from the display controller 104 to the optical true time delay circuit 128, then to a MEMS signal router 304, and finally, to the optical element 130. While FIG. 2 illustrates that the display controller 104, optical true time delay circuit 128, MEMS signal router 304, and the optical element 130 are directly connected (e.g., with no intervening devices or components), one of ordinary skill in the art will recognize that alternative embodiments may include such intervening devices and components. Accordingly, such alternative embodiments are contemplated as falling within the scope of this disclosure. The optical true time delay circuit 128 may be in communication with the MEMS signal router 304 via one or more communication channels (such as a copper trace etched on a printed circuit board (PCB)). The MEMS signal router 304 may also be communicatively coupled to the optical element 130 via one or more communication channels, such as optical free space pathways, guided optical connections including optical fibers, ridge waveguides, slab waveguides, or any other such communication channels or combinations thereof.

In one embodiment, the display controller 104 generates a depth encoded signal, where the depth encoded signal corresponds to a three-dimensional image. The optical true time delay circuit 128 splits the received signal via different physical waveguides, where each waveguide introduces a delay into the received signal. One example of a commercially available optical true time delay circuit 128 is a Silicon Photonics MP-TTD-S 1-XXX series of microresonator based time delay devices, which is available from Morton Photonics, located in West Friendship, Maryland.

From the optical true time delay circuit 128, split and delayed signals are then communicated to the MEMS signal router 304. In one embodiment, the MEMS signal router 304 is configured to transmit each signal to a corresponding etched grating 306A-306F or other element of the optical element 130. The MEMS signal router 304 reflects light output by the optical true time delay circuit 128 to the appropriate optical element (e.g., etched grating 306A-306F) at a high frequency (e.g., more than 60 Hz). The result of each individual signal being displayed in a corresponding layer 306A-306F of the optical element 130 is that the displayed image, which is comprised of the delayed signals, appears in three-dimensions to a viewer viewing the image through the optical element 130.

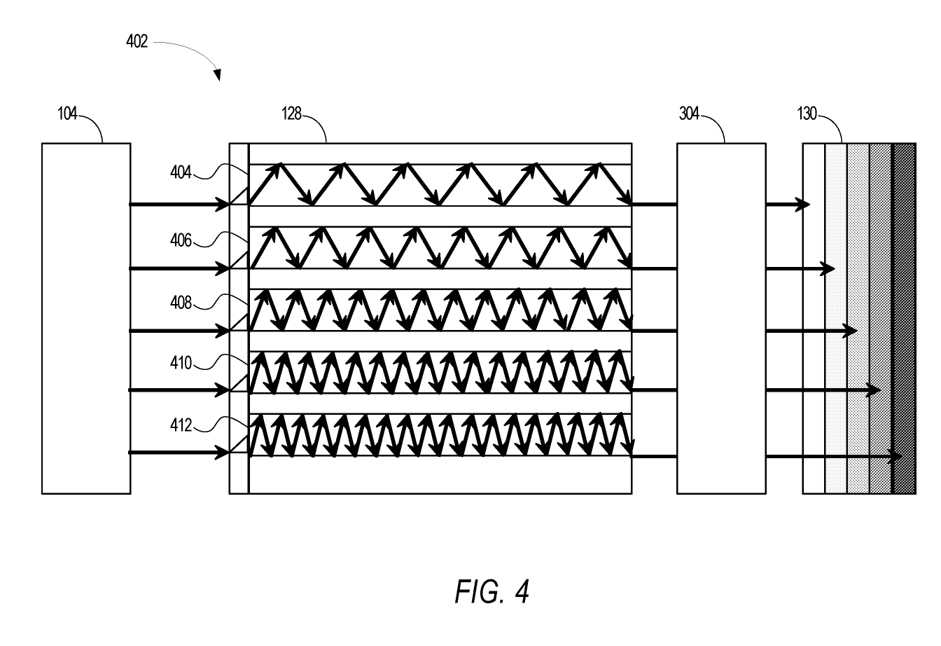

FIG. 4 is another block diagram illustrating the signal pathway 402, according to another example embodiment, from the display controller 104 to the optical element 130. As shown in FIG. 4, the optical true time delay circuit 128 includes a plurality of inputs, such as optical inputs, where each optical input is associated with a physical waveguide. Each of the waveguides introduce a corresponding delay in the received signal, such that the delay varies among the physical waveguides. Further, each of the waveguides may introduce a different delay in the received signal, such that the corresponding signal is received at different times. In one embodiment, the delay in the received signal from the display controller 104 varies between two nanoseconds and ten nanoseconds. Furthermore, and as shown in FIG. 4, each physical waveguide is associated with a layer of the optical element 130, where the signal output by a given physical waveguide is directed to its associated layer by the MEMS signal router 304. In one embodiment, the MEMS signal router 304 includes a MEMS mirror that adjusts its orientation to move in between the delays of the input signals in order to route the delayed signals to different depths. The MEMS signal router 304 may include a programmable memory, such as an EEPROM, that provides the requisite logic for manipulating (e.g., moving and/or oscillating), the MEMS mirror of the MEMS signal router 304.

In this manner, each layer of the optical element 130 is energized with (e.g., displays and/or emits) a different time-delayed signal from the display controller 104. With the arrangement shown in FIG. 4, multiple images can be displayed simultaneously on each layer of the optical element 130. As discussed previously, each layer (e.g., an etched grating or optical element) allow for the transmitted light to convey depth, so each layer equals a different depth of field. For example, and without limitation, where the optical element 130 includes eight layers, the optical element 130 could show light at eight different depths. In this manner, the image resulting from the overlaying of these various time-delayed signals appears to be three-dimensional to a viewer, as each layer of the image appears at a different depth of field.

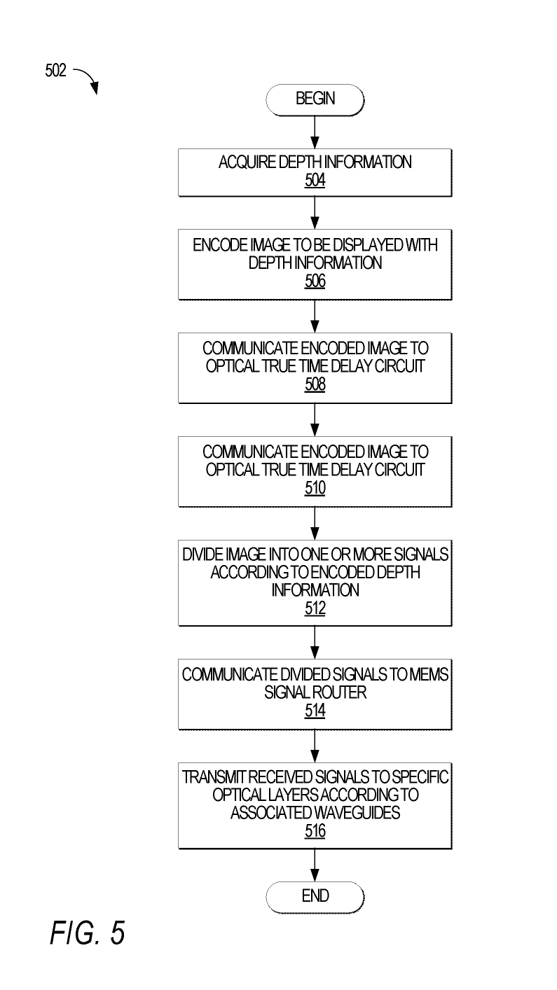

FIG. 5 illustrates a method 502, in accordance with an example embodiment, for communicating a video signal to the optical element 130 via the optical true time delay circuit 128. The method 502 may be implemented by one or more of the components of the AR device 105 and/or transparent optical display 103 illustrated in FIG. 1, and is discussed by way of reference thereto.

Initially, the AR device 105 acquires depth information for an environment via one or more of the sensors 102 (e.g., via one or more of the depth sensors 214 illustrated in FIG. 2) (Operation 504). The depth information may then be stored in the storage device 122 of the AR device 105.

The AR device 105 then encodes an image with depth information (Operation 504). In one embodiment, the dynamic depth encoder 120 encodes the image with the acquired depth information. Alternatively and/or additionally, the image is encoded with depth information selected from the acquired depth information. For example, the image may be encoded with particular depths selected from the available depths of the acquired depth information.

The encoded image is then communicated to the optical true time delay circuit 128 (Operation 508). In one embodiment, the display controller 104, which is in communication with the dynamic depth encoder 120 and the optical true time delay circuit 128, communicates the encoded image to the optical true time delay circuit 128.

During the communication of the encoded image, the display controller 104 divides the encoded image into one or more signals (Operation 512). In one embodiment, the encoded image is divided into signals corresponding to the depth information encoded with the image. In addition, each signal may correspond to a waveguide of the optical true time delay circuit 128 (e.g., one or more of the waveguides 404-412). As one example, waveguide 404 may be associated with depths that are closest to the user of the AR device 105, whereas waveguide 412 is associated with depths that are furthest from the user. In this manner, each waveguide of the optical true time delay circuit 128 may receive a corresponding signal being associated with a particular depth (or range of depths).

The optical true time delay circuit 128 then introduces a time delay into one or more of the signals passing through one or more of its waveguides 404-412. As discussed above, the time delay introduced may range from 2 ns-10 ns. Accordingly, the output of the optical true time delay circuit 128 are one or more signals of the encoded image that are delayed by a predetermined amount of time. The optical true time delay circuit 128 then communicates the delayed signals to corresponding inputs of the MEMS signal router 304 (Operation 514). In turn, the MEMS signal router 304 transmits each of the delayed signals to corresponding etched gratings 306A-306F (e.g., layers) of the optical element 130 (Operation 516). As each layer of the optical element 130 is associated with a particular portion of the encoded image, which is in turn comprised of the one or more delayed signals, the resulting composition of the delayed signals being displayed on the optical element 130 is an image that appears three-dimensional (e.g., appearing to have physical depth) to a user of the AR device 105.

In this manner, this disclosure provides for a real-time, or near real-time, apparatus for displaying depth encoded images on an augmented reality-enabled device. Unlike conventional camera-equipped devices that also display images, the disclosed AR device 105 includes one or more sensors 102 for acquiring depth information about the environment in which the AR device 105 is being used. The AR device 105 then encodes this depth information (or derived depth information) into an image to be displayed on a transparent optical display 103. As the images are encoded with depth information, these images can be displayed to a user of the AR device 105 as if the image truly exists in three-dimensions. Furthermore, as the disclosed arrangement can occur within real-time or near real-time, the images can be displayed to the user without the AR device 105 having to render three-dimensional models of the images. Thus, the disclosed arrangement improves the functioning of the AR device 105 and contributes to the technological advancement of optics and displaying images.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5 are implemented in some embodiments in the context of a machine and an associated software architecture . The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

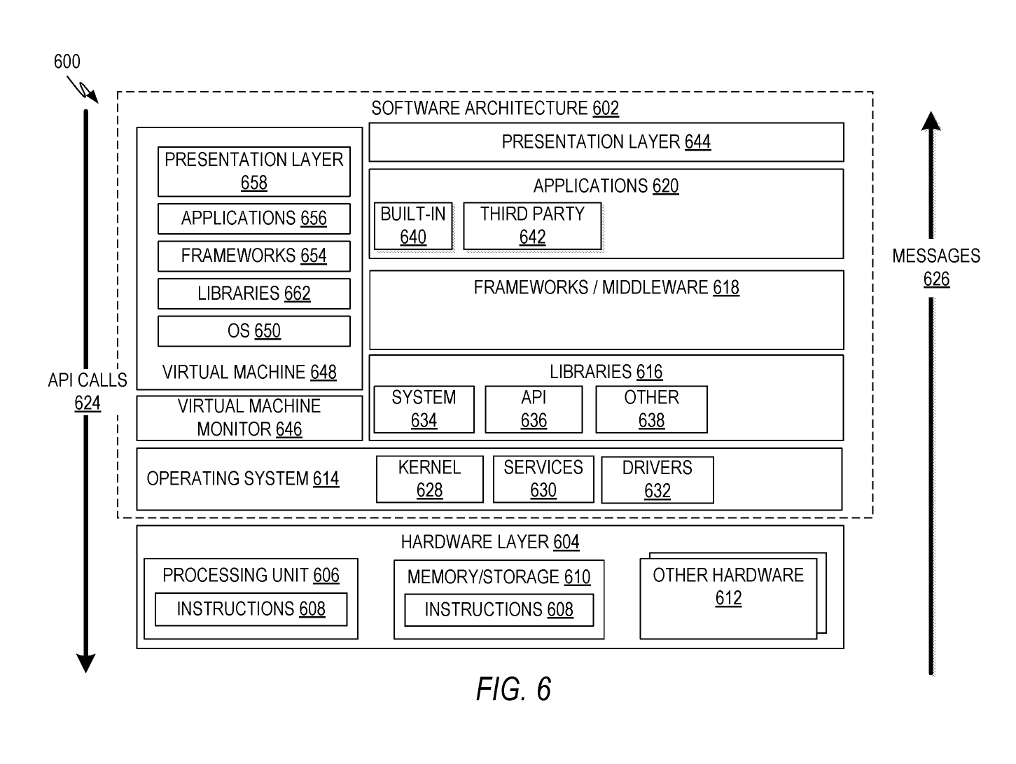

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 600 of FIG. 6 that includes, among other things, processors 610, memory 630, and I/O components 660. A representative hardware layer 604 is illustrated and can represent, for example, the machine 600 of FIG. 6. The representative hardware layer 604 comprises one or more processing units 606 having associated executable instructions 608. Executable instructions 608 represent the executable instructions of the software architecture 602, including implementation of the methods, modules and so forth of FIGS. 1-5. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 600.

In the example architecture of FIG. 6, the software 602 may be conceptualized as a stack of layers where each layer provides particular functionality. For example, the software 602 may include layers such as an operating system 614, libraries 616, frameworks/middleware 618, applications 620 and presentation layer 622. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 includes built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built in applications as well as a broad assortment of other applications. In a specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 642 may invoke the API calls 624 provided by the mobile operating system such as operating system 614 to facilitate functionality described herein.

The applications 620 may utilize built in operating system functions (e.g., kernel 628, services 630 and/or drivers 632), libraries (e.g., system 634, APIs 636, and other libraries 638), frameworks / middleware 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware machine (such as the machine of FIG. 6, for example). A virtual machine is hosted by a host operating system (operating system 614 in FIG. 6) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

### Example Machine Architecture and Machine-Readable Medium

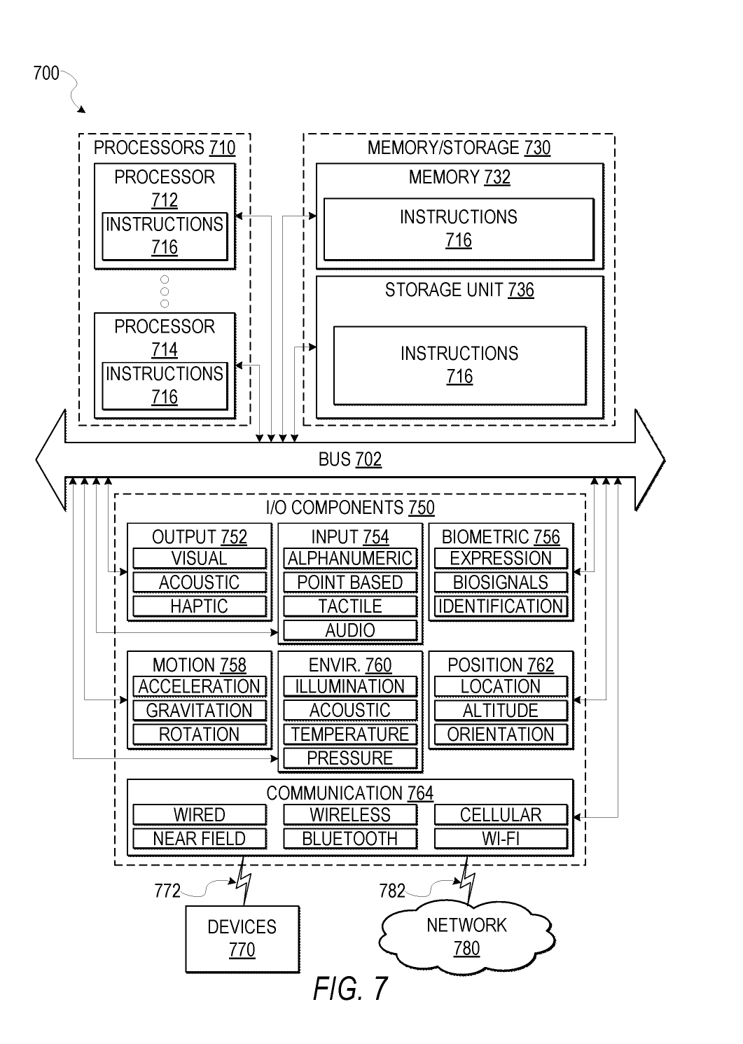

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the methodologies discussed herein. Additionally, or alternatively, the instructions may implement any modules discussed herein. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A device configured to display augmented reality images, the device comprising:
a display controller configured to communicate a depth encoded image, the depth encoded image including a plurality of image portions, where each image portion is associated with a determined depth;
a time delay circuit in communication with the display controller and configured to receive the depth encoded image, the time delay circuit comprising a plurality of waveguides, each waveguide configured to delay a corresponding image portion of the depth encoded image selected from the plurality of image portions; and
an optical element in communication with the time delay circuit, the optical element configured to display one or more image portions selected from the plurality of image portions.

2. The device of claim 1, further comprising:
a depth sensor configured to acquire a plurality of depth values, wherein the determined depth associated with each of the image portions selected from the plurality of image portions is assigned a depth value selected from the plurality of depth values.

3. The device of claim 1, further comprising:
a micro-electro-mechanical systems (MEMS) signal router in communication with the time delay circuit and the optical element, the MEMS signal router configured to transmit at least one image portion delayed by at least one waveguide of the time delay circuit to the optical element.

4. The device of claim 1, wherein each waveguide of the time delay circuit is configured to delay the corresponding image portion by different amounts of time.

5. The device of claim 4, wherein the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

6. The device of claim 1, wherein each image portion of the depth encoded image is assigned a waveguide of the time delay circuit based on its corresponding determined depth.

7. The device of claim 1, wherein the optical element comprises a plurality of layers, each layer selected from the plurality of layers being associated with a corresponding waveguide of the time delay circuit.

8. A method for displaying augmented reality images, the method comprising:
communicating, by a display controller, a depth encoded image, the depth encoded image including a plurality of image portions, where each image portion is associated with a determined depth;
receiving, by a time delay circuit, the depth encoded image, the time delay circuit comprising a plurality of waveguides, each waveguide configured to delay a corresponding image portion of the depth encoded image selected from the plurality of image portions; and
displaying, by an optical element, one or more image portions selected from the plurality of image portions.

9. The method of claim 8, further comprising:
acquiring, by a depth sensor, a plurality of depth values, wherein the determined depth associated with each of the image portions selected from the plurality of image portions is assigned a depth value selected from the plurality of depth values.

10. The method of claim 8, further comprising:
transmitting, by a micro-electro-mechanical systems (MEMS) signal router in communication with the time delay circuit and the optical element, at least one image portion delayed by at least one waveguide of the time delay circuit to the optical element.

11. The method of claim 8, further comprising:
delaying, by each waveguide of the time delay circuit, the corresponding image portion by different amounts of time.

12. The method of claim 11, wherein the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

13. The method of claim 8, wherein each image portion of the depth encoded image is assigned a waveguide of the time delay circuit based on its corresponding determined depth.

14. The method of claim 8, wherein the optical element comprises a plurality of layers, each layer selected from the plurality of layers being associated with a corresponding waveguide of the time delay circuit.

15. A machine-readable medium storing computer-executable instructions that, when executed by one or more hardware processors, cause an augmented reality device to perform a plurality of operations, the operations comprising:
communicating, by a display controller, a depth encoded image, the depth encoded image including a plurality of image portions, where each image portion is associated with a determined depth;
receiving, by a time delay circuit, the depth encoded image, the time delay circuit comprising a plurality of waveguides, each waveguide configured to delay a corresponding image portion of the depth encoded image selected from the plurality of image portions; and
displaying, by an optical element, one or more image portions selected from the plurality of image portions.

16. The machine-readable medium of claim 15, wherein the plurality of operations further comprises:
acquiring, by a depth sensor, a plurality of depth values, wherein the determined depth associated with each of the image portions selected from the plurality of image portions is assigned a depth value selected from the plurality of depth values.

17. The machine-readable medium of claim 15, wherein the plurality of operations further comprises:
transmitting, by a micro-electro-mechanical systems (MEMS) signal router in communication with the time delay circuit and the optical element, at least one image portion delayed by at least one waveguide of the time delay circuit to the optical element.

18. The machine-readable medium of claim 15, wherein the plurality of operations further comprises:
delaying, by each waveguide of the time delay circuit, the corresponding image portion by different amounts of time.

19. The machine-readable medium of claim 18, wherein the delay associated with each waveguide of the time delay circuit increases with each waveguide of the time delay circuit, where a first waveguide is associated with a lowest delay and a last waveguide is associated with a highest delay, the lowest delay and the highest delay forming a range of delays of the time delay circuit.

20. The machine-readable medium of claim 15, wherein each image portion of the depth encoded image is assigned a waveguide of the time delay circuit based on its corresponding determined depth.
